(19) United States
(12) Patent Application Publication
(10) Pub. No.: US 2023/0387493 A1
(43) Pub. Date: Nov. 30, 2023

(54) Battery-Powered Work Machine with On-Demand Cooling and Conditioning of the Battery

(71) Applicant: Wacker Neuson Produktion GmbH & Co. KG, Reichertshofen (DE)

(72) Inventors: Patrick Diller, Hohenwart (DE); Alto Weiskopf, Altomünster (DE); Christian Glanz, Dachau (DE); Steffen Galle, Landshut (DE); Christopher Hackl, Freinhausen (DE)

(21) Appl. No.: 18/201,395

(22) Filed: May 24, 2023

(30) Foreign Application Priority Data
May 25, 2022 (DE) 10 2022 113 284.6

(51) Int. Cl. H01M 10/63; E01C 19/40; E01C 21/00; E02D 3/068; H05K 7/20; H01M 10/613; H01M 10/6235; H01M 10/6563; H01M 10/48; H01M 10/635

(52) U.S. Cl. CPC H01M 10/63; E01C 19/402; E01C 21/00; E02D 3/068; H05K 7/20909; H01M 10/613; H01M 10/6235; H01M 10/6563; H01M 10/486; H01M 10/635; E01C 23/0933

(57) ABSTRACT

A work machine includes a working device for generating a working motion; an electric motor for driving the working device; an electric energy storage device for supplying the electric motor with electric current; and a cooling device for cooling the energy storage device. The cooling device comprises at least one fan device for generating a cooling air flow which can be directed over the energy storage device. At least one temperature sensor is provided for detecting a temperature, and a control device is provided for controlling the fan device as a function of the temperature detected by the temperature sensor.

### BACKGROUND OF THE INVENTION

### 1. Field of the Invention

The invention relates to a work machine, in particular a battery-powered work machine, such as a vibratory rammer, a vibratory plate for soil compaction, a floor saw, etc. The invention moreover relates to methods for conditioning the batteries used in the work machine.

### 2. Description of the Related Art

Different drive concepts are used in such work or construction machines. Whereas in the past such machines were largely driven by internal combustion engines, electric drives are increasingly gaining acceptance, wherein an electric motor is supplied with electrical energy by a battery present on the machine and an associated converter.

In such machines, a fan wheel is provided on the electric motor serving as the drive motor, which permanently generates a cooling air flow during operation of the motor, which cooling air flow can also be used to cool the battery and the converter. An example of this is described in DE 10 2010 055 632 A1.

In this, cooling is not on-demand, but rather occurs automatically during operation of the electric motor. This means that the components are only cooled when the motor is running and the device is thus in operation. Moreover, the components are also cooled when there is no need for cooling inasmuch as the components have not yet reached a critical temperature.

In the case of battery-powered devices of this type, it is moreover necessary to first activate the battery by a pushbutton or switch provided on the battery before starting up the machine. The operator can then switch on the electric motor by a machine switch within a specified period of time (for example, 30 seconds) and thus start up the machine. After switching off the electric motor, the battery must again be deactivated by the pushbutton.

The cooling of the components occurs exclusively during operation of the drive motor, such that preconditioning or postconditioning or temperature control of the battery is not possible. If, for example, the battery has already been heated by a previous charging or discharging process, this can lead to a shortened runtime, especially in the case of devices with higher power consumption, since the maximum permissible temperature of the battery is reached more quickly. This can lead to a forced switching off of the entire machine or even to damage to components (battery, converter).

Conversely, the components located in the cooling air flow permanently generated during engine operation can be cooled even if, with regard to the temperature of the components, this cooling is not yet necessary. Particularly at low outside temperatures, this can lead to the components, especially the battery, being operated for longer periods of time below their intended operating temperature (“feel-good temperature”).

The use of fans on battery-powered devices, whether by a fan wheel directly on the drive motor or by a separate fan, increases the energy requirement, since the fan is constantly running, as soon as the battery is activated and current can be drawn from the battery.

### SUMMARY OF THE INVENTION

The invention is based on the task of specifying a work machine with improved thermal management via demand-driven active cooling and temperature conditioning.

The task is solved by a work machine including a working device for generating a working motion, an electric motor for driving the working device, an electric energy storage device for supplying the electric motor with electric current, and a cooling device for cooling the energy storage device. The cooling device comprises at least one fan device for generating a cooling air flow which can be directed over the energy storage device. At least one temperature sensor is provided for detecting a temperature, and a control device is provided for controlling the fan device as a function of the temperature detected by the temperature sensor.

The work machine may in particular be a construction machine, such as a vibratory rammer, a vibratory or vibrating plate for soil compaction, or a floor saw for cutting asphalt pavement or concrete.

The control device is capable of controlling and in particular of switching the fan device on and off and thereby the cooling air flow. The fan device may comprise a fan and a fan motor driving the fan, wherein the fan motor can, in particular, be provided separately from the actual drive motor (electric motor) of the work machine.

The control of the fan device by the control device may, in particular, occur by monitoring whether the temperature exceeds or falls below predefined limit values. By way of example, if a predefined upper temperature limit is exceeded, the fan device can be switched on in order to cool the component to be cooled with the aid of the cooling air flow generated as a result, in particular the energy storage device, which may comprise a battery.

The fan device can also comprise several fans, which can each be controlled jointly or individually by the control device. In this way, the cooling air flow can be generated as needed at the points where cooling is required.

The control allows at least a switching on or off of the fan device. It is likewise also possible to set or control a fan speed.

In accordance with another aspect of the invention, a work machine includes a working device for generating a working motion, an electric motor for driving the working device, an electric energy storage device for supplying the electric motor with electric current, a motor switching device for switching the electric motor on and off by an operator, an operator control device which can be actuated by the operator for activating and deactivating the energy storage device, and a control device for deactivating the energy storage device as a function of a working state of the work machine. The working state is selected from the group consisting of: the expiration of a predetermined first time period after activation of the energy storage device by the operator control device, without the electric motor having been switched on by the motor switching device; expiration of a predetermined second time period after the electric motor has been switched off by the motor switching device.

In the case of battery-operated work machines, it has become established that the energy storage battery must first be activated by actuating an operator control device (for example, a pushbutton or switch). Only then does the battery or, alternatively, a control provided on the battery, release the electric current. When the battery has been activated, it is in a standby state so that its electrical energy can be used.

The first time period is specified when the battery is activated, within which time period the operating mode should or alternatively can be started by switching on the electric motor. If the electric motor is not started during this first period, the battery is once again deactivated.

If the motor has once again been switched off after a working operation, the expiration of a second time period is monitored. When this second time period has expired without any further activity such as, for example, the switching on of the electric motor, the control device deactivates the battery.

In the work machine, a cooling device may be provided for cooling the energy storage device, wherein the cooling device comprises at least one fan device for generating a cooling air flow which can be directed over the energy storage device, wherein at least one temperature sensor is provided for detecting a temperature, and wherein the control device is configured to control the fan device as a function of the temperature detected by the temperature sensor.

As in the embodiment described above, the control device may evaluate the measured values of the temperature sensor and compare them, for example, with temperature limit values in order to correspondingly control the fan device.

A converter may be provided for converting the current from the energy storage device and supplying the current to the electric motor, wherein the cooling device can be provided for cooling the converter in addition to cooling the energy storage device, wherein the cooling air flow can be directed via the converter device.

Depending on the configuration, the cooling air flow can thereby be directed between the energy storage device and the converter device. By way of example, the fan can be arranged in the cooling air flow between the energy storage device and the converter device. Accordingly, the cooling air flow can initially cool the energy storage device and then subsequently the converter device if it is correspondingly directed past the components.

A temperature sensor may be provided for detecting at least one temperature at the work machine, selected from the group: temperature of the energy storage device, temperature of the converter, temperature of the electric motor, ambient temperature, temperature at an air inlet of a cooling air duct provided for directing the cooling air flow, temperature at an outlet of the cooling air duct.

As a consequence, at least one temperature sensor or, if necessary, a plurality of temperature sensors can be provided at different locations or, alternatively, components on the work machine. The respective temperature values detected by the temperature sensors are supplied to the control device, which control device takes appropriate measures, such as, for example, the switching on or off, or upward or downward adjusting of the fan device.

A temperature sensor can thereby be provided at the energy storage device and/or at the converter.

A temperature limit value can be stored in the control device, wherein due to the control device the detected temperature can be comparable to the temperature limit value, and wherein when the detected temperature exceeds the temperature limit value, the control device switches the fan device on.

The control device may be configured to control the fan device as a function of the temperature detected by the temperature sensor and as a function of an operating state of the work machine. If a plurality of temperature sensors are present, the control device may also control the fan device (or the plurality of fan devices) as a function of the plurality of temperatures detected by the plurality of temperature sensors.

The operating state of the work machine may be selected from the group: energy storage device switched off, energy storage device switched on, electric motor switched on. Depending on the operating state, the control device takes action and switches, for example, the fan device on or off, taking into account the temperatures detected.

The control device can be configured to control the fan device as a function of the temperature detected by the temperature sensor and as a function of the operating state of the work machine, in such a way that the fan device is also activated in the first time period and/or in the second time period if the detected temperature is above a predetermined temperature limit value.

As elucidated above, the criterion of the working state refers to the expiry of a predetermined first time period or second time period before the electric motor (drive motor) is switched on or after the electric motor is switched off. During these time periods, the energy storage device can, for example, be cooled by activating the fan device, even if the electric motor itself is not switched on. This allows, for example, an energy storage device that was charged shortly before use and still exhibits a high temperature due to the charging process to be cooled during the standby phase (first time period), before it is used to supply the electric motor with electrical energy.

Likewise, the energy storage device can still be cooled after the electric motor has been switched off if its detected temperature is above the specified temperature limit value.

The control device can be configured to control the fan device as a function of at least one of the following parameters: state of charge of the energy storage device, state of aging of the energy storage device, voltage provided by the energy storage device, model type of the energy storage device. This means that the control device can take into account additional parameters beyond the pure temperature values, in particular the temperature of the energy storage device, which can have an influence on the activity of the fan device. If necessary, a mapping control can be defined for this, in which the various parameters are mapped, in connection with the respective consequences (ventilation on, ventilation off, strength of the cooling air flow).

A maximum temperature limit value may be stored in the control device, which value is predefined as an upper limit value for operation of the energy storage device system, wherein the temperature in the energy storage device system is detected by a temperature sensor, wherein due to the control device the detected temperature is comparable to the maximum temperature limit value, and wherein, if it is determined that the maximum temperature limit value is exceeded by the temperature detected, the control device switches off the electric motor or prevents the electric motor from being switched on.

In this case, it is monitored that the temperature in the energy storage device does not exceed the maximum temperature limit. If this were, however, to occur, the energy storage device system must not be subjected to any further load in order to prevent damage. In this case, the drive motor of the work machine is switched off immediately by the control device or alternatively the motor is prevented from being switched on. In this operating state, current can only be drawn from the energy storage device system to operate the fan device.

The control device can be integrated into a control system of the converter. The converter has electronic components anyway, so that further electronic components may also be arranged at this point, which are required for the control device.

In accordance with another aspect of the invention, a method for preconditioning an energy storage device on a work machine comprises the steps of activating the energy storage device by an operator, setting a first time period after activation, within which period an electric motor serving as a drive motor of the work machine can be started; deactivating the energy storage device if the electric motor has not been started during the first time period; and, during the first time period, monitoring of a temperature of the energy storage device and activation of a fan device to generate a cooling air flow for the energy storage device if the temperature of the energy storage device is above a predetermined temperature limit.

In accordance with still another aspect of the invention a method for postconditioning an energy storage device on a work machine comprises the steps of switching off an electric motor serving as a drive motor of the work machine, which is supplied with electrical energy by an activated energy storage device; setting a second time period starting with the switching off of the electric motor; during the second time period, maintenance of the energy storage device in an activated state; and during the second time period, monitoring of a temperature of the energy storage device and activation of a fan device to generate a cooling air flow for the energy storage device if the temperature of the energy storage device is above a predetermined temperature limit.

After the second time period has elapsed, the energy storage device can be deactivated.

### BRIEF DESCRIPTION OF THE DRAWINGS

These and other advantages and features of the invention are elucidated in more detail below on the basis of examples with the aid of the accompanying figures. Wherein:

FIG. 1 shows a vibratory rammer in schematic side view, as an example of a work machine according to the invention;

FIG. 2 shows a vibratory plate in schematic side view, as an example of a work machine according to the invention;

FIG. 3 shows the basic construction of a cooling device with on-demand control;

FIG. 4 shows control situations for controlling the cooling device as a function of different working and operating states; and

FIG. 5 shows a flow chart elucidating pre- and postconditioning.

### DETAILED DESCRIPTION

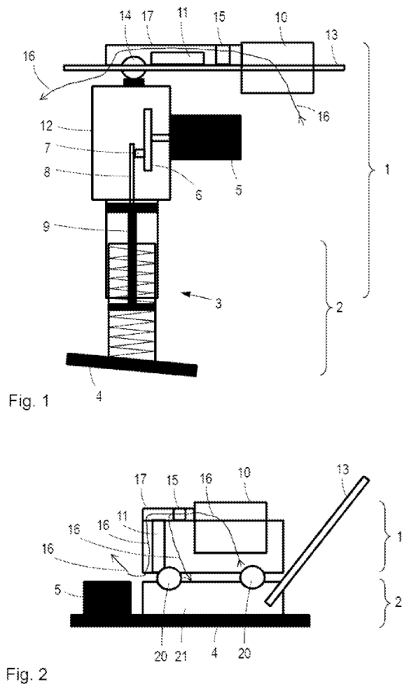

FIG. 1 and FIG. 2 each show an example of a work machine with cooling of a battery and of a converter. In the examples shown—as will be elucidated later—a cooling air flow is generated which is directed over the battery and the converter in order to cool the two components. The invention can, however, also be applied to other cooling concepts, in particular to other cooling air flow routings.

FIG. 1 schematically shows a vibratory or vibrating rammer, with a top mass 1 and a bottom mass 2 that is movable relative to the top mass 1. The top mass 1 and the bottom mass 2 are coupled together by a spring device 3 known per se. A ground contact plate 4 is provided on the underside of the bottom mass 2 for ground compaction.

A drive is provided with an electric motor 5 on the top mass 1, which electric motor rotationally drives a crank wheel 6, which is coupled to a connecting rod 8 via a crank pin 7. The connecting rod 8 is connected to a ramming piston 9 so that the rotary motion of the crank wheel 6 is converted into a back and forth motion of the ramming piston 9. The linear motion of the ramming piston 9 is then finally transmitted via the spring device 3 to the ground contact plate 4, which performs the actual ramming motion.

A battery 10 serving as an electrical energy storage device is provided to supply energy to the electric motor 5.

As regards voltage and frequency, the electric current supplied by the battery 10 is converted or alternatively transformed into a current suitable for the electric motor 5 by a converter 11 serving as a converter device. In particular, it may be possible to generate an alternating current for the electric motor 5 from the direct current stored in the battery 10.

The crank wheel 6, the crank pin 7 and the connecting rod 8 are accommodated in a crankcase 12, to which the electric motor 5 is also attached. In one variant, the electric motor 5 may also be arranged largely inside the crankcase 12.

A handle device 13 belonging to the top mass 1 and configured as a gripping bar is attached to the upper side of the crankcase 12. For vibration decoupling of the handle device 13, a vibration decoupling device 14, for example, in the form of rubber buffers, is arranged between the handle device 13 and the crankcase 12. As a result, the handle device 13 is pivotable within certain limits relative to the rest of the top mass 1, in particular relative to the crankcase 12, in order to protect an operator who grips the gripping bar or the handle device 13 as intended, at the right-hand end as depicted in FIG. 1, from being subjected to excessively strong vibrations.

Both the battery 10 and the converter 11 are attached to or alternatively are supported by the handle device 13. In so doing, it is possible that the battery 10 is exchangeably attached to the handle device 13, so that it can, in each case, be replaced by a fresh battery 10.

A fan device 15 is spatially arranged between the battery 10 and the converter 11, which fan device comprises a fan, for example, a ventilator, and a fan motor.

The fan device 15 generates a cooling air flow 16 by sucking air in over the battery 10 and forcing it downstream over the converter 11 until the cooling air flow 16 re-enters the environment. The routing of the cooling air flow 16 is symbolically represented by an arrow in FIG. 1.

A cover 17, for example, a plastic hood, is provided to better direct the cooling air flow 16 and to protect the various components.

In a variant not shown, the fan device 15 can also be arranged upstream of the battery 10 or downstream of the converter 11 in order to generate the cooling air flow 16 (cf. direction of arrow) in a suitable manner.

FIG. 2 shows another embodiment of the work machine as a vibratory or vibrating plate. Components that are functionally similar or identical to those in the embodiment of FIG. 1 are designated with the same reference numbers.

Accordingly, the vibration plate also comprises a top mass 1 and a bottom mass 2, wherein the bottom mass 2 is movable relative to the top mass 1. For this purpose, vibration decoupling elements 20 are provided between the top mass 1 and the bottom mass 2.

A ground contact plate 4 is configured on the bottom mass 2. The electric motor 5 is arranged on the ground contact plate 4, which electric motor drives a vibration exciter 21. The vibration exciter 21 may, for example, have one or a plurality of unbalance shafts which are set in rotation by the electric motor 5 serving as a drive motor in order to generate the desired vibrations. The vibrations are then introduced directly into the soil to be compacted by the ground contact plate 4.

The battery 10 providing the energy for the electric motor 5 is arranged on the top mass 1, together with the converter 11.

As in the embodiment of FIG. 1, the fan device 15 is arranged between the battery 10 and the converter 11 to bring about the cooling air flow 16 through the battery 10 and along the converter 11. As can be seen, the cooling air flow 16 can be directed downstream of the fan device 15 in such a way that cooling air flow 16 flows around the converter 11 on as many sides as possible or at least on both sides. Depending on the configuration, the cooling effect is also sufficient if the battery 10 and/or the converter 11 are only supplied with flow on one side only.

The cover 17 is provided for improved direction of the cooling air flow 16.

In the case of the vibration plate, the handle device 13 is in the form of a drawbar which can be guided by an operator and is attached to the bottom mass 2.

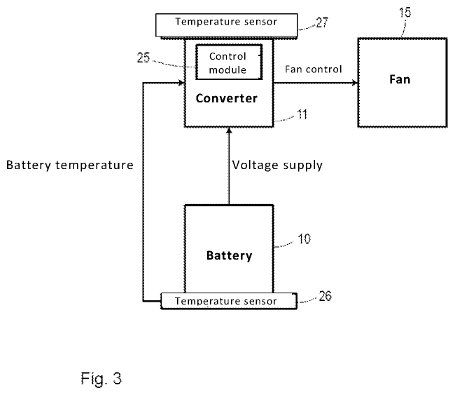

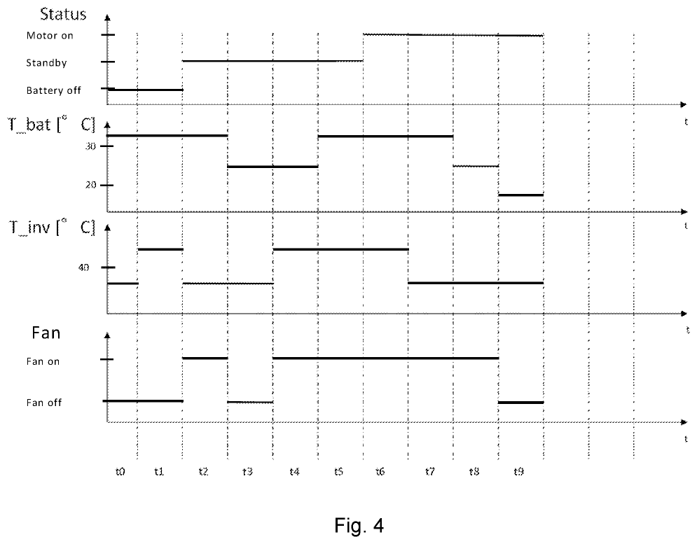

FIG. 3 shows the schematic construction of a cooling device according to the invention for implementing on-demand cooling, which can be used, for example, in one of the work machines shown in FIG. 1 or FIG. 2.

The battery 10 is used to supply voltage to the converter 11. A control module 25 serving as a control device is also provided as a component of the converter 11. The control module 25 can be an integral part of the converter 11. It can, however, also be arranged separately from the converter 11, for example, in another area of the work machine. The arrangement of the control module 25 on or alternatively in the converter 11 does however lend itself to use, since sensitive electronic components are already provided for the converter, which are accordingly protected against vibrations, contamination and the ingress of moisture. By integrating the control module 25 in the converter 11, it is thus possible to avoid additional complexity that would otherwise be required by corresponding additional protective measures for the control module 25.

The control module 25 controls the fan 15. In particular, the control module can switch the fan 15 on and off. Likewise, it is possible that the control module 25 is configured to change the speed of the fan as needed.

A temperature sensor 26 is provided on the battery 10 and a temperature sensor 27 is provided on the converter 11 to monitor the cooling needs. The temperature sensors 26, 27 can be arranged on the outer walls or alternatively housing walls of battery 10 and converter 11. They may, however, also be integrated into the inside of the housings if this is structurally possible.

The measurement results of the temperature sensors 26, 27 are fed to the control module 25, which compares the measurement results with predefined engine characteristics or limit values. Depending on the situation detected, in particular if the temperature exceeds or falls below a predefined limit value, the control module 25 controls the fan 15 to generate or switch off a cooling air flow or alternatively to increase it or to lessen it.

Other temperature sensors may be provided at suitable locations in the work machine to provide information to the control module 25 which assists a cooling on-demand. Such information may include, for example, the outside temperature, the temperature in a crankshaft gear (vibratory rammer) or a vibration exciter (vibratory plate), or the temperature in a drive motor (for example, electric motor 5).

FIG. 4 shows various parameters by way of example and their development over time t. In particular, various operating and switching states are shown in order to explain the operation of the on-demand cooling.

In the upper line, the status of the work machine is shown, with the different states “battery off”, “standby” and “motor on”.

In the “battery off” state, the battery is deactivated and does not supply any voltage.

In the “standby” state, the battery 10 has been actuated by the operator by pressing a corresponding operating element, for example, a pushbutton, and is accordingly in standby mode. In this state, the battery provides electrical voltage for the operation of the work machine.

In the “motor on” state, the drive motor 5 of the work machine is activated and the work machine can perform the intended work, for example, the compaction of the soil by a vibratory rammer or a vibratory plate.

The line below in FIG. 4 shows exemplary temperature values T_bat at the battery 10, which are detected by the temperature sensor 26. In the example shown, the temperature values jump between approx. 33° C. (a temperature that is too high for battery 10), 25° C. (optimum operating temperature for battery so-called “feel-good temperature”) and 17° C. (temperature that is too low). These temperature values are however only given as examples. Of course, other values can also be measured in practice during operation of the work machine, depending on the battery type.

In a manner similar to the temperature values at battery 10, the line below in FIG. 4 shows measured temperature values T_inv at converter 11. Here the temperature values jump from values below 40° C. and above 40° C.

The bottom line of FIG. 4 shows the switching positions of fan 15, namely “fan on” or “fan off”.

This results in the following switching states, provided by way of example in FIG. 4, for the different time intervals t0 to t9:
t0: Battery off (supplies no current), temperature at battery (T_bat) too high, temperature at converter (T_inv) low. The fan is switched off since battery supplies no voltage.
t1: Similar situation to t0. In addition, the temperature at the converter T_inv is high. The battery does not supply any current, the fan remains off.
t2: The operator has activated the battery 10 so that the battery is in standby. The temperature values correspond to those of t0. Since electrical voltage is however now available from the battery 10, the fan is switched on.
t3: All temperature values are in the optimum range. The fan is off.
t4: Similar situation to t3, however the temperature at converter T_inv is high. Therefore the fan is on.
t5: Both temperature values T_bat and T_inv are high, the fan is on.
t6: The motor is started and in operation. The temperature values are high, the fan is on.
t7: The temperature value of the battery T_bat is high, the fan is on.
t8: Both temperature values are low. However, since the temperature value of the battery was high shortly before at t7, cooling is continued and the fan remains on.
t9: The temperature of the battery T_bat is very low. Cooling is no longer required and could even be rather detrimental—if the ambient temperature is low. The ventilation is off.

In summary, it can be said when the battery 10 is switched off, the fan 15 is always off. If the battery 10 is in standby and the battery temperature T_bat is high (for example, >30° C.), the fan 15 is always on. If the motor (electric motor is switched on and the battery temperature T_bat>20° C. or the converter temperature T_inv>40° C., the fan is on.

Cooling only takes place as soon as the battery 10 is activated in order to avoid deep discharge.

In the use of work machines, especially in their form as construction machines, there often exists the possibility that the battery has too high a temperature even before the machine is started up. This may be due to the battery having been stored, for example, in the sun, or having been charged shortly before the start of use. Likewise, the battery temperature may be high after the machine has been switched off because the battery has previously been heavily stressed by use of the drive motor.

For this purpose, a conditioning method is provided by which the battery 10 remains active before and after operation of the machine and accordingly can still be cooled in the case of need. It can also be provided that the machine can only be switched on when the battery temperature is within a favorable range. If the temperature is too high, the machine can correspondingly not be started.

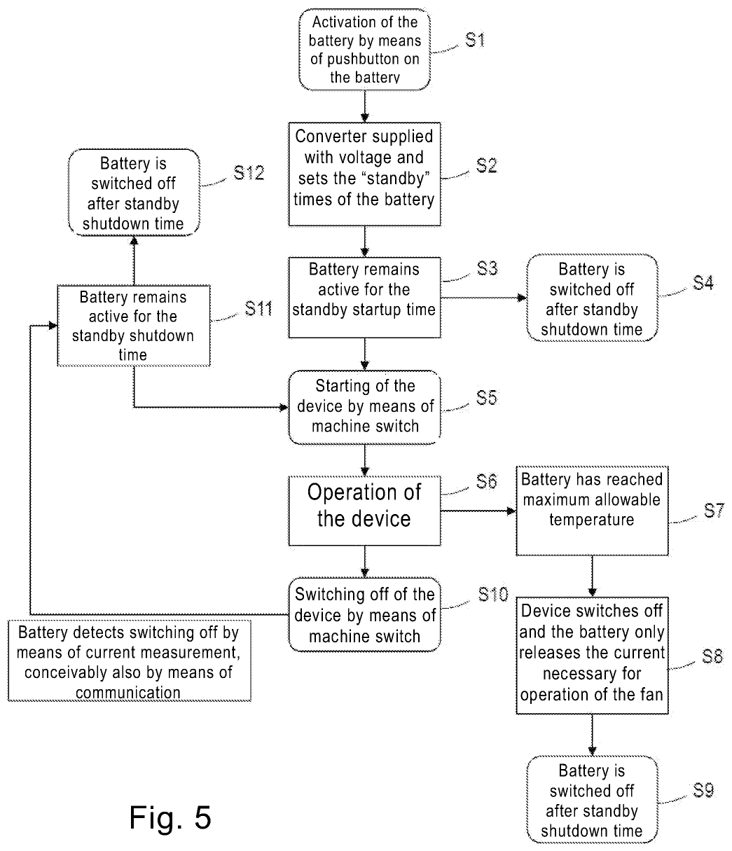

FIG. 5 shows an example of the functional steps of the conditioning method.

In step S1, the battery is actuated through activation of a pushbutton provided on the battery. From then on, the battery provides an electrical voltage that can be used by the work machine.

In particular, the converter or alternatively the control module provided there is supplied with voltage in step S2 and specifies so-called “standby” times or time periods (first time period) for the battery.

In step S3, the battery remains active for the specified “standby startup” time.

Provided the operator does not initiate any further measures, the battery switches off in step S4 after the “standby startup” time period has elapsed.

When the operator, however, switches on the work machine in step S5 by a machine switch provided in the service area and, in particular, activates, for example, the drive motor of the device, operation of the device is possible in step S6.

Parallel to this, the monitoring of the temperature continues as shown in FIG. 3, elucidated above. If the control module 25 detects in step S7 that the battery has reached its maximum permissible temperature, the control module switches off the drive motor in step S8. The battery can then only supply the current required to operate the fan device 15 so that the battery can continue to be cooled.

After the specified “standby shutdown” time (second time period) has elapsed, the battery switches off in step S9.

If no exceeding of the battery temperature (step S7) is detected during the operation of the device in step S6, the device can be switched off after the end of work by actuating the machine switch in step S10.

The battery recognizes the switching off of the device by the fact that no more current is drawn. Additionally or alternatively, it is also possible that an information exchange takes place between the motor control or the motor switch on the one hand and the battery on the other hand, and that the battery in this way receives the information that the motor has been switched off.

After the device has been switched off in step S10, the battery remains active in step S11 for the “standby shutdown” time (second time period). In this phase, the battery can thus continue to be cooled.

In step S12, the battery switches off after the “standby shutdown” time has elapsed. The battery is then no longer actively cooled because the fan is no longer supplied with current.

The duration of time for which the battery should remain in standby after the device is partially switched off before it completely switches itself off again can be, for example, 3 or 5 minutes. During this period of time, the operator can switch the device back on by actuating the machine switch and continue operation without needing to once again activate the battery. In the case of other devices, it may be unlikely that operation will be resumed. Therefore, in this case, the battery must not remain active for a longer time period, such that the battery switches off again after a shorter minimum time (for example, 30 seconds) if no new start of the machine has occurred in the meantime.

By way of the on-demand cooling elucidated above, the cooling device can be configured to be more energy efficient than active fans that are not specifically controlled, since the fans do not need to run continuously.

On-demand cooling of the components can extend the maximum possible runtime because the delta between the current temperature and the maximum allowable temperature for the components in question, especially the battery, is increased by the preconditioning and postconditioning. By way of example, the pre-cooling of the battery allows the battery to remain in operation longer before its temperature has exceeded the maximum allowable limit temperature.

By operating the components at their “feel-good” temperatures, the life of the cells of the battery and the electronic components in the converter can be extended.

The switch-on and switch-off concept elucidated with reference to FIG. 5 makes it easier and faster to start up the machine during short pauses. In particular, the operator is not required to activate the battery again and again before each start of the machine.

1. A work machine, comprising:
a working device for generating a working motion;
a electric motor for driving the working device;
a electric energy storage device for supplying electric current to the electric motor; and comprising
a cooling device for cooling the energy storage device;
wherein
the cooling device comprises at least one fan device for generating a cooling air flow which can be directed over the energy storage device;
at least one temperature sensor is provided for detecting a temperature; and
wherein
a control device is provided for controlling the fan device as a function of the temperature detected by the temperature sensor.

2. A work machine, comprising
a working device for generating a working motion;
an electric motor for driving the working device;
an electric energy storage device for supplying electric current to the electric motor;
a motor switching device for switching the electric motor on and off under control of an operator;
an operator control device that can be actuated by the operator to activate and deactivate the energy storage device; and comprising
a control device for deactivating the energy storage device as a function of a working state of the work machine;
wherein the working state is selected from the group consisting of:
expiration of a predetermined first time period after activation of the energy storage device by the operator control device, without the electric motor having been switched on by the motor switching device; and
expiration of a predetermined second time period after the electric motor has been switched off by the motor switching device.

3. The work machine according to claim 2, comprising
a cooling device for cooling the energy storage device;
wherein
the cooling device comprises at least one fan device for generating a cooling air flow which can be directed over the energy storage device;
at least one temperature sensor is provided for detecting a temperature; and
wherein
the control device is configured to control the fan device as a function of the temperature detected by the temperature sensor.

4. The work machine according to claim 3, wherein
a converter is provided for converting the current from the energy storage device and for supplying the current to the electric motor;
the cooling device is configured to cool the converter in addition to cooling the energy storage device; and wherein
the cooling air flow can be directed via the converter device;

5. The work machine according to claim 4, wherein a temperature sensor is provided for detecting at least one temperature at the work machine selected from the group consisting of:
a temperature of the energy storage device;
a temperature of the converter;
a temperature of the electric motor;
an ambient temperature;
a temperature at an air inlet of a cooling air duct provided for directing the cooling air flow; and
a temperature at an outlet of the cooling air duct.

6. The work machine according to claim 2, wherein
a temperature limit value is stored in the control device;
due to the control device, the detected temperature is comparable to the temperature limit value;
when the detected temperature exceeds the temperature limit value, the control device switches the fan device on.

7. The work machine according to claim 2, wherein the control device is configured to control the fan device as a function of the temperature detected by the temperature sensor and as a function of an operating state of the work machine.

8. The work machine according to claim 7, wherein the operating state of the work machine is selected from the group consisting of:
the energy storage device being switched off;
the energy storage device being switched on; and
the electric motor being switched on.

9. The work machine according to claim 2, wherein the control device is configured to control the fan device as a function of the temperature detected by the temperature sensor and as a function of the operating state of the work machine, in such a way that the fan device is also activated in the first time period and/or in the second time period if the detected temperature is above a predetermined temperature limit value.

10. The work machine according to claim 2, wherein the control device is configured to control the fan device as a function of at least one of the following parameters:
a state of charge of the energy storage device;
a state of aging of the energy storage device;
a voltage provided by the energy storage device; and
a model type of the energy storage device.

11. The work machine according to claim 2, wherein
a maximum temperature limit value is stored in the control device, which maximum value is predefined as an upper limit value for operation of the energy storage device;
the temperature in the energy storage device is detected by a temperature sensor;
the control device is configured to compare the detected temperature to the maximum temperature limit value; and wherein
if it is determined that the maximum temperature limit value is exceeded by the detected temperature, the control device switches off the electric motor or prevents the electric motor from being switched on.

12. The work machine according to claim 4, wherein the control device is integrated into a control system of the converter.

13. A method for preconditioning an energy storage device on a work machine, comprising the steps of:
activating the energy storage device by an operator;
setting a time period after activation, within which time period an electric motor serving as a drive motor of the work machine can be started;
deactivating the energy storage device if the electric motor has not been started during the time period; and
during the time period, monitoring a temperature of the energy storage device and activating a fan device to generate a cooling air flow for the energy storage device if the temperature of the energy storage device is above a predetermined temperature limit.

14. A method for postconditioning an energy storage device on a work machine, comprising the steps of:
switching off an electric motor serving as a drive motor of the work machine, which is supplied with electrical energy by an activated energy storage device;
setting a time period starting with the switching off of the electric motor;
during the time period, maintaining the energy storage device in an activated state; and
during the time period, monitoring a temperature of the energy storage device and activating a fan device to generate a cooling air flow for the energy storage device if the temperature of the energy storage device is above a predetermined temperature limit.

15. The work machine according to claim 1, wherein
a temperature limit value is stored in the control device;
due to the control device, the detected temperature is comparable to the temperature limit value;
when the detected temperature exceeds the temperature limit value, the control device switches the fan device on.

16. The work machine according to claim 1, wherein the control device is configured to control the fan device as a function of the temperature detected by the temperature sensor and as a function of an operating state of the work machine.

17. The work machine according to claim 16, wherein the operating state of the work machine is selected from the group consisting of:
the energy storage device being switched off;
the energy storage device being switched on; and
the electric motor being switched on.

18. The work machine according to claim 1, wherein the control device is configured to control the fan device as a function of at least one of the following parameters:
a state of charge of the energy storage device;
a state of aging of the energy storage device;
a voltage provided by the energy storage device; and
a model type of the energy storage device.

19. The work machine according to claim 1, wherein
a maximum temperature limit value is stored in the control device, which maximum value is predefined as an upper limit value for operation of the energy storage device;
the temperature in the energy storage device is detected by a temperature sensor;
the control device is configured to compare the detected temperature to the maximum temperature limit value; and wherein
if it is determined that the maximum temperature limit value is exceeded by the detected temperature, the control device switches off the electric motor or prevents the electric motor from being switched on.

20. The work machine according to claim 1, wherein the work machine comprises one of a vibratory rammer, a vibratory or vibrating plate for soil compaction, and a floor saw for cutting asphalt pavement or concrete.
